(19) United States
(12) Patent Application Publication
(10) Pub. No.: US 2020/0052823 A1
(43) Pub. Date: Feb. 13, 2020

(54) TERMINAL APPARATUS, BASE STATION APPARATUS, COMMUNICATION METHOD, AND PROGRAM

(71) Applicants: SHARP KABUSHIKI KAISHA, Sakai City, Osaka (JP); OSAKA UNIVERSITY, Suita-shi, Osaka (JP)

(72) Inventors: JUNGO GOTO, Sakai City, Osaka (JP); OSAMU NAKAMURA, Sakai City, Osaka (JP); SEIICHI SAMPEI, Osaka (JP); SHINSUKE IBI, Osaka (JP)

(21) Appl. No.: 16/497,218

(22) PCT Filed: Mar. 28, 2018
(86) PCT No.: PCT/JP2018/013008

§ 371 Date: Sep. 24, 2019

(30) Foreign Application Priority Data
Mar. 31, 2017 (JP) 2017-071820

(51) Int. Cl. H04L 1/14; H04L 1/18

(52) U.S. Cl. CPC H04L 1/14; H04L 1/1812

(57) ABSTRACT

A terminal apparatus for performing radio communication with another terminal apparatus via a base station apparatus, the terminal apparatus including: a transmitter configured to transmit, to the base station apparatus, a signal of data addressed to the other terminal apparatus; a receiver configured to receive a signal from the base station apparatus to the other terminal apparatus; and a controller configured to determine whether the base station apparatus has successfully received the signal of the data transmitted from the transmitter to the other terminal apparatus, by using the signal from the base station apparatus to the other terminal apparatus received by the receiver.

### TECHNICAL FIELD

The present invention relates to a terminal apparatus, a base station apparatus, a communication method, and a program.

This application claims priority based on JP 2017-071820 filed on Mar. 31, 2017, the contents of which are incorporated herein by reference.

### BACKGROUND ART

The fifth generation mobile communication has been demanded to support mission critical Internet of Things (IoT) requiring higher reliability and lower latency. Long Term Evolution (LTE), LTE-Advanced, and the like of 3rd Generation Partnership Project (3GPP) involves Hybrid Automatic Repeat reQuest (HARQ) control performed in a channel of a physical layer used for transmitting and receiving data, for both uplink and downlink. Thus, communications between terminal apparatuses A and B via a base station apparatus require four types of communications including: transmission of data from the terminal apparatus A to the base station apparatus; an HARQ response from the base station apparatus to the terminal apparatus A; transmission of data from the base station apparatus to the terminal apparatus B; and the HARQ acknowledgment from the terminal apparatus B to the base station apparatus.

Of these, the interval between the transmission of data and the HARQ acknowledgment is defined to be four subframes according to the specification in a case of Frequency Division Duplex (FDD) and is defined to be four subframes or more according to the specification, depending on a combination between the UL/DL configuration and a subframe used for transmitting data, in a case of Time Division Duplex (TDD) (for example, see NPL 1).

### CITATION LIST

### Non Patent Literature

NPL 1: 3GGP, “3rd Generation Partnership Project; Technical Specification Group Radio Access Network; Evolved Universal Terrestrial Radio Access (E-UTRA); Physical layer procedures (Release 13)”, 3GPP TS 36.213 V13.4.0 (2016 December), Jan. 2, 2017.

### SUMMARY OF INVENTION

### Technical Problem

However, communications between terminal apparatuses via a base station apparatus involves a delay time (response time) which is equal to or longer than a sum of a time interval between a data transmission and an HARQ acknowledgment in communications from the terminal apparatus, which is a transmission source, to the base station apparatus and a time interval between data transmission and the HARQ acknowledgment in communications from the base station apparatus to the terminal apparatus which is a transmission destination.

One aspect of the present invention is made in view of such a circumstance, and provides a terminal apparatus, a base station apparatus, a communication method, and a program capable of reducing a delay time in communication between terminal apparatuses.

### Solution to Problem

(1) The present invention is made to solve the above-described problem, and an aspect of the present invention provides a terminal apparatus for performing radio communication with another terminal apparatus via a base station apparatus, the terminal apparatus including: a transmitter configured to transmit, to the base station apparatus, a signal of data addressed to the other terminal apparatus; a receiver configured to receive a signal from the base station apparatus to the other terminal apparatus; and a controller configured to determine whether the base station apparatus has successfully received the signal of the data transmitted from the transmitter to the other terminal apparatus, by using the signal from the base station apparatus to the other terminal apparatus received by the receiver.

(2) Another aspect of the present invention provides the above-described terminal apparatus in which, in a case that the receiver receives the signal from the base station apparatus to the other terminal apparatus, the controller compares data obtained by decoding the signal to the other terminal apparatus received and data transmitted from the transmitter to the other terminal apparatus, and determine whether reception by the base station apparatus has been successful.

(3) Another aspect of the present invention provides the above-described terminal apparatus in which, in a case that the receiver receives a negative acknowledgment to the signal transmitted from the transmitter to the other terminal apparatus, the controller determines that the signal transmitted from the transmitter to the other terminal apparatus has not been successfully received by the base station apparatus.

(4) Another aspect of the present invention provides a base station apparatus including: a receiver configured to receive, from a first terminal apparatus, a signal addressed to a second terminal apparatus; and a transmitter configured to transmit no acknowledgment to the first terminal apparatus and transmit a signal addressed to the second terminal apparatus, based on the signal addressed to the second terminal apparatus that has been successfully received in a case that the signal addressed to the second terminal apparatus has been successfully received by the receiver, and transmit a negative acknowledgment to the first terminal apparatus in a case that the signal addressed to the second terminal apparatus has not been successfully received by the receiver.

(5) Another aspect of the present invention provides a communication method for a terminal apparatus for performing radio communication with another terminal apparatus via a base station apparatus, the communication method including: a first step of transmitting, to the base station apparatus, a signal of data addressed to the other terminal apparatus; a second step of receiving a signal from the base station apparatus to the other terminal apparatus; and a third step of determining whether the base station apparatus has successfully received the signal of the data, addressed to the other terminal apparatus, that is transmitted in the first step, by using the signal from the base station apparatus to the other terminal apparatus received in the second step.

(6) Another aspect of the present invention provides a communication method in a base station apparatus, the communication method including: a first step of receiving, from a first terminal apparatus, a signal addressed to a second terminal apparatus; a second step of transmitting no acknowledgment to the first terminal apparatus and transmitting a signal addressed to the second terminal apparatus, based on the signal addressed to the second terminal apparatus that has been successfully received in a case that the signal addressed to the second terminal apparatus has been successfully received in the first step; and a third step of transmitting a negative acknowledgment to the first terminal apparatus in a case that the signal addressed to the second terminal apparatus has not been successfully received in the first step.

(7) Another aspect of the present invention provides a program for causing a computer in a terminal apparatus for performing radio communication with another terminal apparatus via a base station apparatus to perform: transmitting, to the base station apparatus, a signal of data addressed to the other terminal apparatus, as a transmitter; receiving a signal from the base station apparatus to the other terminal apparatus; and determining whether the base station apparatus has successfully received the signal of the data transmitted from the transmitter to the other terminal apparatus, as a controller, by using the signal from the base station apparatus to the other terminal apparatus received by the receiver.

(8) Another aspect of the present invention provides a program for causing a computer in a base station apparatus to perform: receiving, from a first terminal apparatus, a signal addressed to a second terminal apparatus, as a receiver; and transmitting no acknowledgment to the first terminal apparatus and transmitting a signal addressed to the second terminal apparatus, based on the signal addressed to the second terminal apparatus that has been successfully received in a case that the signal addressed to the second terminal apparatus has been successfully received by the receiver, and transmitting a negative acknowledgment to the first terminal apparatus in a case that the signal addressed to the second terminal apparatus has not been successfully received by the receiver, as a transmitter.

### Advantageous Effects of Invention

According to an aspect of the present invention, a delay time in communications between terminal apparatuses can be reduced.

### BRIEF DESCRIPTION OF DRAWINGS

FIG. 1 is a schematic diagram illustrating a configuration of a wireless communication system 100 according to a first embodiment.

FIG. 2 is a schematic block diagram illustrating a configuration of a base station apparatus 10 according to the first embodiment.

FIG. 3 is a schematic block diagram illustrating a configuration of a terminal apparatuses 20 according to the first embodiment.

FIG. 4 is a sequence diagram illustrating an example of operations in the radio communication system 100 according to the first embodiment.

FIG. 5 is a flowchart illustrating operations of a controller 23 of the terminal apparatuses 20 according to the first embodiment.

FIG. 6 is a sequence diagram illustrating an example of operations in the radio communication system 100 according to a modification of the embodiment.

FIG. 7 is a diagram illustrating a configuration of a radio communication system 100a according to a second embodiment.

FIG. 8 is a sequence diagram illustrating operations in the radio communication system 100a according to the second embodiment.

FIG. 9 is a diagram illustrating a configuration of a radio communication system 100b according to a third embodiment.

FIG. 10 is a sequence diagram illustrating operations in the radio communication system 100b according to the third embodiment.

### DESCRIPTION OF EMBODIMENTS

### First Embodiment

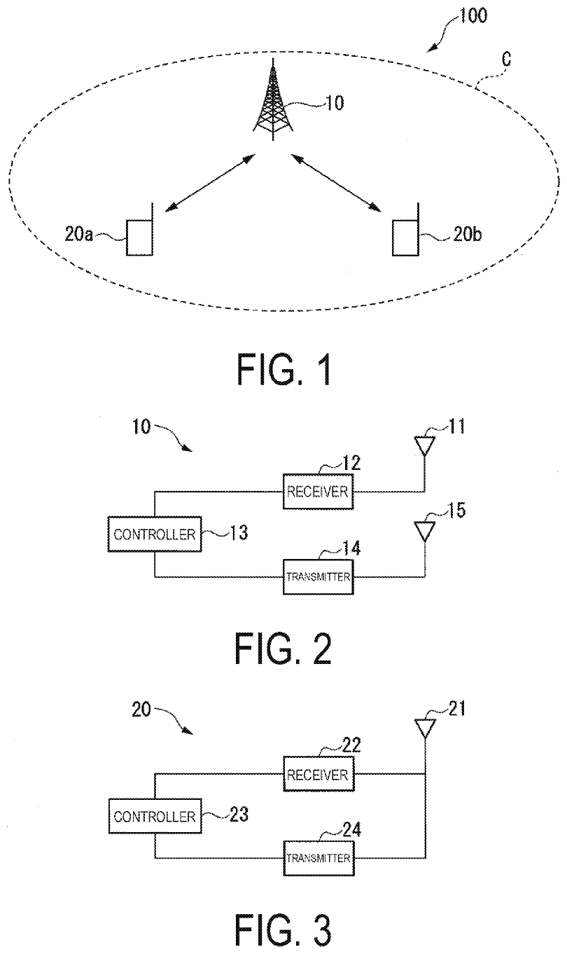

Hereinafter, a first embodiment of the present invention will be described in detail with reference to the drawings. FIG. 1 is a schematic diagram illustrating a configuration of a radio communication system 100 according to the first embodiment of the present invention. The wireless communication system 100 is a mobile communication system that uses, for example, a Time Division Duplex (TDD) scheme of Long Term Evolution (LTE) or LTE-Advanced and has the features described below. The radio communication system 100 includes a base station apparatus 10 (eNB) and terminal apparatuses 20a and 20b (Mobile station apparatus, User Equipment (UE)). In FIG. 1, a cell C is a cell provided by the base station apparatus 10, and the terminal apparatuses 20a and 20b are served in the cell C and perform radio communications with the base station apparatus 10.

The base station apparatus 10 communicates with the terminal apparatuses 20a and 20b that are served in the cell C. The terminal apparatus 20a is, for example, a control apparatus that controls the terminal apparatus 20b, which is a controlled apparatus. The terminal apparatus 20a, for example, controls the terminal apparatus 20b to collect a measurement result from a sensor included in the terminal apparatus 20b. Note that there may be a plurality of the terminal apparatuses 20a and a plurality of the terminal apparatuses 20b. For example, one terminal apparatus 20a may control the plurality of terminal apparatuses 20b, and the plurality of terminal apparatuses 20a may control one terminal apparatus 20b.

In a case that the terminal apparatus 20a (the first terminal apparatus) transmits data (for example, a control command) addressed to the terminal apparatus 20b (the second terminal apparatus), and the base station apparatus 10 successfully receives the data, the base station apparatus 10 transmits the data to the terminal apparatus 20b. Here, successful reception indicates that data is recovered without an error in a receiver by demodulation and/or decoding processing. A redundant bit, such as Cyclic Redundancy Check (CRC), is added to ensure that there is no error, and may be used for error determination. In a case of receiving a signal in which the base station apparatus 10 has transmitted the data to the terminal apparatus 20b, the terminal apparatus 20a determines that the base station apparatus 10 has successfully received the data. Note that the base station apparatus 10 may not transmit, to the terminal apparatus 20a, an acknowledgment (ACK) for indicating that the data has been successfully received, even in a case that the data has successfully been received. The above description similarly applies to a case that the terminal apparatus 20b transmits data (e.g., control result and measurement result) addressed to the terminal apparatus 20a, with the terminal apparatus 20a and the terminal apparatus 20b simply swapped.

The terminal apparatus 20a and the terminal apparatus 20b have similar configurations related to radio communication, and are thus collectively referred to as a terminal apparatus 20. FIG. 2 is a schematic block diagram illustrating a configuration of the base station apparatus 10 according to the present embodiment. The base station apparatus 10 includes a receive antenna 11, a receiver 12, a controller 13, a transmitter 14, and a transmit antenna 15. The receive antenna 11 is an antenna used to receive a signal from the terminal apparatus 20. The receiver 12 receives a signal from the terminal apparatus 20 via the receive antenna 11. The receiver 12 decodes the received signal to obtain received data. The received data includes a control signal addressed to the base station apparatus 10 from the terminal apparatus 20, and data addressed to another terminal apparatus 20 from the terminal apparatus 20.

The controller 13 controls the entire base station apparatus 10. For example, the controller 13 generates control signals related to data transfer between the terminal apparatuses 20 and communications with the terminal apparatus 20. For example, in a case that the data addressed to the terminal apparatus 20b is included in the received data from the terminal apparatus 20a, the controller 13 causes the transmitter 14 to transmit the data to the terminal apparatus 20b. The controller 13 allocates a radio resource to each of the terminal apparatuses 20, and causes the transmitter 14 to transmit a control signal (UL Grant, DL Grant) for indicating the allocated radio resource to the terminal apparatus 20. Furthermore, in a case that the receiver 12 detects an abnormality while decoding the signal received from the terminal apparatus 20, the controller 13 causes the transmitter 14 to transmit a negative acknowledgment (NACK) to the terminal apparatus 20. Here, the abnormality indicates the receiver 12 has failed to recover the data without an error through demodulation processing and/or decoding processing.

The transmitter 14 generates a transmit signal by modulating transmit data to be transmitted to the terminal apparatus 20, under the control by the controller 13, and transmits the transmit signal via the transmit antenna 15. The transmit data includes data addressed to the terminal apparatuses 20 and a control signal addressed to the terminal apparatus 20. Note that the control signal includes a negative acknowledgment (NACK) in HARQ control and a radio resource allocation (UL Grant, DL Grant) for the terminal apparatus 20. The transmit antenna 15 is an antenna used to transmit a signal to the terminal apparatus 20.

FIG. 3 is a schematic block diagram illustrating a configuration of the terminal apparatus 20 according to the present embodiment. The terminal apparatus 20 includes a transmit and receive antenna 21, a receiver 22, a controller 23, and a transmitter 24. The transmit and receive antenna 21 is an antenna used to transmit and receive signals from the base station apparatus 10. The receiver 22 receives a signal from the base station apparatus 10 via the transmit and receive antenna 21. The receiver 22 decodes the received signal to obtain received data. The received data includes control signals addressed to the terminal apparatus 20 from the base station apparatus 10, data addressed to the terminal apparatus 20 from the other terminal apparatus 20, and control signals and data transmitted from the base station apparatus 10 to the other terminal apparatus 20.

The controller 23 controls the entire terminal apparatus 20. For example, the controller 23 controls an operation of the terminal apparatus 20 serving as a control apparatus or a controlled apparatus, and controls Hybrid Automatic Repeat reQuest (HARQ) for the communications with the base station apparatus 10. The operation of the terminal apparatus serving as a control apparatus includes generating data such as a control command transmitted to the controlled apparatus, and acquiring data from the controlled apparatus. The operation of the terminal apparatus serving as a controlled apparatus includes acquiring data such as a control command from the control apparatus, controlling the controlled apparatus based on the control command, and generating data such as control result transmitted to the control apparatus.

The Hybrid Automatic Repeat reQuest (HARQ) control for communications with the base station apparatus 10 includes a HARQ control of data addressed to the other terminal apparatus 20. For example, the controller 23 determines that the base station apparatus 10 has successfully received data addressed to the other terminal apparatus 20 in a case that the receiver 22 receives the data that is the same as the data, addressed to the other terminal apparatus 20, which has been transmitted from the base station apparatus 10 to the other terminal apparatus 20.

The transmitter 24 generates a transmit signal by modulating transmit data to be transmitted to the base station apparatus 10, under the control by the controller 23, and transmits the transmit signal via the transmit and receive antenna 21. The transmit data includes data addressed to the other terminal apparatuses 20 and a control signal addressed to the base station apparatus 10. The control signal may include a scheduling request used to request an uplink radio resource for example.

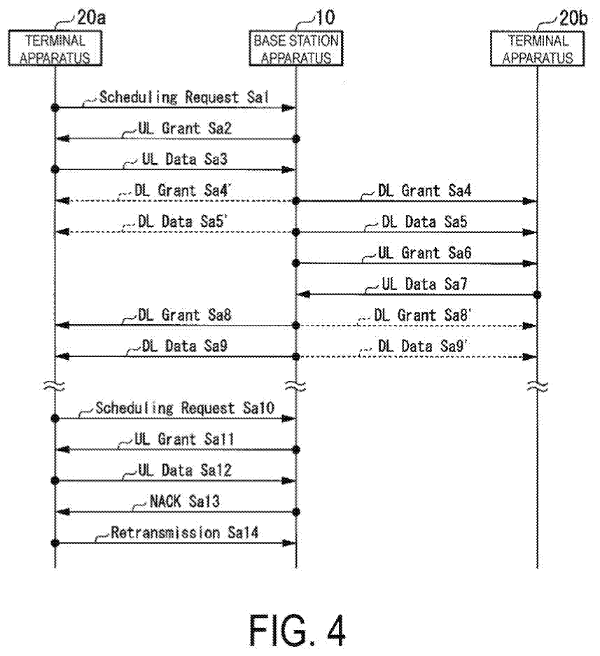

FIG. 4 is a sequence diagram illustrating an example of operations in the radio communication system 100 according to the present embodiment. The sequence diagram illustrated in FIG. 4 illustrates an example of operations in a case that the terminal apparatuses 20a, which is a control apparatus served in the cell C of the base station apparatus 10, transmits a control command to the terminal apparatus 20b, which is a controlled apparatus served in the cell C of the base station apparatus 10.

First of all, the controller 23 of the terminal apparatuses 20a generates a scheduling request to request a radio resource to be used for transmission of the control command, and causes the transmitter 24 to transmit the scheduling request to the base station apparatus 10 (Sa1). Here, the scheduling request is transmitted in a Physical Uplink Control Channel (PUCCH). The scheduling request may be transmitted in one subframe (two slots, 1 msec in a case that the subcarrier interval is 15 kHz), may be transmitted in one slot (seven OFDM symbols), or may be transmitted in one mini-slot with a shorter transmission time. A parameter related to the time required for the terminal apparatus 20a to transmit the scheduling request (the subcarrier interval or transmission in any one of the units including one subframe/one slot/one mini-slot) may be notified from the base station apparatus 10 by using control information (control information in a higher layer, which is RRC layer signaling for example) based on a requirement of a delay time in the terminal apparatus 20a. In a case that the receiver 12 receives the scheduling request from the terminal apparatus 20a, the controller 13 of the base station apparatus 10 determines the uplink radio resource allocation for the terminal apparatus 20a, generates a control signal (UL Grant) for indicating the radio resource, and causes the transmitter 24 to transmit the control signal to the terminal apparatus 20a (Sa2). The controller 13 adds an ID of the terminal apparatus 20a (C-RNTI for example) to the control signal (UP Grant), and transmits the resultant signal by using a control channel in a physical layer such as Physical Downlink Control Channel (PDCCH), Enhanced Physical Downlink Control Channel (EPDCCH), and Machine Type Communications (MTC) Physical Downlink Control Channel (MPDCCH). Furthermore, the UL Grant may be transmitted by using a Downlink Control Information (DCI) format, such as DCI format 0 or 4, and may include a transmit parameter such as Resource Assignment (RA) information, information of transmit power control (TPC Command), and Modulation and Coding Scheme (MCS).

In a case that the receiver 22 receives the control signal (UL Grant), the controller 23 of the terminal apparatus 20a generates, as uplink data, data (UL Data) that is addressed to the terminal apparatus 20b and includes a control command or the like, and causes the transmitter 24 to transmit the data to the base station apparatus 10 by using the radio resource indicated by the received control signal (Sa3). The radio resource is, for example, a resource block in a subframe that is later than the control signal indicating the radio resource by a prescribed number of subframes. The Physical Uplink Shared Channel (PUSCH) is allocated in the resource block. Thus, the data transmission in sequence Sa3 is performed by using this PUSCH. In addition, the data transmission may also be performed by using a Self-contained subframe. In this case, downlink control information and uplink data are transmitted in a single subframe. Moreover, the downlink control information and the uplink data may be transmitted on a slot basis or a mini-slot basis. In this case, the uplink data transmission is performed by using a resource block in a subframe at a prescribed timing from the control signal indicating the radio resource.

In a case that the receiver 12 successfully receives and decodes the data addressed to the terminal apparatus 20b, the controller 13 of the base station apparatus 10 determines which of the terminal apparatuses 20 is the destination of data in the data. Here, the data is addressed to the terminal apparatus 20b, and thus the controller 13 determines the radio resource to be used for transmitting the data to the terminal apparatus 20b. The controller 13 causes the transmitter 14 to transmit a control signal (DL Grant) for indicating the radio resource and the data (DL Data) (Sa4, Sa5, Sa4′, Sa5′). Here, the DL Grant and the DL Data may be transmitted in the same subframe or in the same slot.

The controller 13 adds an ID of a group including the terminal apparatus 20a and the terminal apparatus 20b to the control signal, and transmits the resultant signal by using a control channel in a physical layer such as Physical Downlink Control Channel (PDCCH), Enhanced Physical Downlink Control Channel (EPDCCH), and Machine Type Communications (MTC) Physical Downlink Control Channel (MPDCCH). The group ID is, for example, a Radio Network Temporary Identity (RNTI), and is added by scrambling, with the RNTI, Cyclic Redundancy Check (CRC) to be added to the control signal.

The terminal apparatus 20a and the terminal apparatus 20b are notified of the group ID in advance, through signaling in a higher layer such as a Radio Resource Control (RRC) layer. The ID of the group may be a unique ID of the terminal apparatus 20b, and the terminal apparatus 20a may be notified of the unique ID of the terminal apparatus 20b, which is a controlled apparatus, from the base station apparatus 10 through signaling from the base station apparatus 10 in a higher layer such as a RRC layer. In a case that the terminal apparatuses 20a may transmit data to multiple terminal apparatuses 20b, the terminal apparatuses 20a may be notified of an ID of a group including each of the multiple terminal apparatuses 20b, from the base station apparatus 10 through signaling in a higher layer such as a RRC layer. The data transmission in sequences Sa5 and Sa5′ is performed by using the radio resource determined by the controller 13. The radio resource is, for example, a resource block of the same subframe as the control signal indicating the radio resource. The Physical Downlink Shared Channel (PDSCH) is allocated in the resource block. Thus, the data transmission of data in the sequences Sa5 and Sa5′ is performed by using the PDSCH.

In a case that the receiver 22 receives the control signal (DL grant) to which the group ID is added, the controller 23 of each of the terminal apparatuses 20a and 20b causes the receiver 22 to receive the data in the radio resource indicated by the control signal (DL Data). The controller 23 of the terminal apparatus 20a determines whether the data received in the sequence Sa5′ matches the data transmitted in the sequence Sa3, and in a case that the data matches, the controller 23 of the terminal apparatus 20a determines that the base station apparatus 10 has successfully received the data transmitted in the sequence Sa3. The controller 23 of the terminal apparatus 20b controls the terminal apparatus 20b in accordance with a control command or the like included in the data received in the sequence Sa5.

A prescribed period of time (a prescribed number of subframes) later after the data is transmitted to the terminal apparatus 20b in the sequence Sa5, the controller 13 of the base station apparatus 10 determines the uplink radio resource allocation for the terminal apparatus 20b. Then, the controller 13 generates a control signal (UL Grant) for indicating the radio resource, and causes the transmitter 24 to transmit the control signal to the terminal apparatus 20b (Sa6). The transmission of the control signal is similar to that in the sequence Sa2, except that the control signal is transmitted to the terminal apparatus 20b.

In a case that the receiver 22 receives the control signal (UL Grant), the controller 23 of the terminal apparatus 20b generates, as uplink data, data (UL Data) that is addressed to the terminal apparatus 20a and includes a result of control based on the control command or the like, and causes the transmitter 24 to transmit the data to the base station apparatus 10 by using the radio resource indicated by the received control signal (Sa7). Here, in a case that the terminal apparatus 20b has not yet prepared the data of the result of the control based on the control command, the terminal apparatus 20b may transmit the information of the time at which the data is ready to be transmitted (for example, after several milliseconds (msec)), by using the radio resource indicated by the received control signal. In a case that the receiver 12 successfully receives and decodes the data addressed to the terminal apparatus 20a, the controller 13 of the base station apparatus 10 determines which of the terminal apparatuses 20 is the destination of data in the data.

In this sequence, the data is addressed to the terminal apparatus 20a, and thus the controller 13 determines the radio resource to be used for transmitting the data to the terminal apparatus 20a. The controller 13 causes the transmitter 14 to transmit a control signal (DL Grant) for indicating the radio resource and the data (DL Data) (Sa8, Sa9, Sa8′, and Sa9′). The transmission of the control signal (DL Grant) and the data (DL Data) is similar to that in sequences Sa4, Sa5, Sa4′, and Sa5′.

In a case that the receiver 22 receives the control signal (DL grant) to which the group ID is added, the controller 23 of each of the terminal apparatuses 20a and 20b causes the receiver 22 to receive the data in the radio resource indicated by the control signal (DL Data). The controller 23 of the terminal apparatus 20b determines whether the data received in the sequence Sa9′ matches the data transmitted in the sequence Sa7, and in a case that the data matches, the controller 23 of the terminal apparatus 20b determines that the base station apparatus 10 has successfully received the data transmitted in the sequence Sa7. The controller 23 of the terminal apparatus 20a controls the terminal apparatus 20a in accordance with a result of the control or the like included in the data received in the sequence Sa9. Although not illustrated in the figure, the controller 23 of the terminal apparatus 20a may cause the transmitter 24 to transmit an acknowledgment to the base station apparatus 10 in a case that the receiver 22 has successfully received the data in the sequence Sa9.

The sequences Sa1 to Sa9 described above are sequences in which all the transmission and reception are successfully performed. Sequences in which the base station apparatus 10 fails to successfully receive what is transmitted from the terminal apparatuses 20a will be described below. First of all, the sequences Sa1° to Sa12 that are the same as the sequences Sa1 to Sa3 are performed, and then the controller 13 of the base station apparatus 10 determines whether the receiver 12 has successfully received the data transmitted in the sequence Sa12 (UL Data).

In this sequence, the controller 13 determines that the reception has not been successful, and thus determines that there has been an abnormality. A predetermined period of time (a predetermined number of subframes) later after the sequence Sa12, the controller 13, which determines that there has been the abnormality, causes the transmitter 14 to transmit a negative acknowledgment (NACK)(Sa13).

The negative acknowledgment is transmitted by using, for example, a physical layer control channel such as Physical Hybrid-ARQ Indicator Channel (PHICH) or PDCCH. In a case that the receiver 22 receives the negative acknowledgment transmitted in the sequence Sa13, the controller 23 of the terminal apparatuses 20a causes the transmitter 24 to perform a retransmission of the data that has been transmitted in the sequence Sa12 (Sa14).

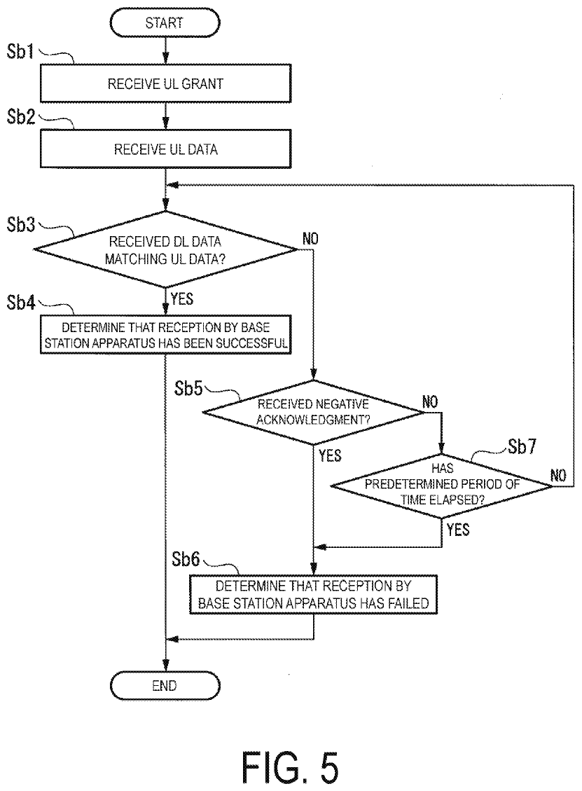

FIG. 5 is a flowchart illustrating operations of a controller 23 of the terminal apparatus 20 according to the present embodiment. The flowchart illustrated in FIG. 5 is a flowchart to determine whether the terminal apparatus 20 has successfully transmitted data in the uplink or not. First of all, in a case that the receiver 22 receives a control signal (UL Grant) indicating an uplink radio resource (Sb1), the controller 23 causes the transmitter 23 to transmit the data (UL Data) by using the radio resource (Sb2).

Next, the controller 23 compares the data transmitted in step Sb2 (UL Data) with data obtained by decoding the signal received by the receiver 22 (DL Data), and determines whether the receiver 22 has received data matching the transmitted data (Sb3). In a case that the controller 23 determines that the matching data has been received (Yes in Sb3), the controller 23 determines that the base station apparatus 10 has successfully received the data transmitted in step Sb2 (Sb4). On the other hand, in case that the controller 23 determines that the matching data has not been received in step Sb3 (No in Sb3, the controller 23 determines whether a negative acknowledgment (NACK) for the data (UL Data) transmitted in step Sb2 has been received by the receiver 22 (Sb4). In a case that the controller 23 determines that the negative acknowledgment has been received (Yes in Sb5), the controller 23 determines that the base station apparatus 10 has failed to receive the data transmitted in step Sb2 (Sb6).

Furthermore, in a case that the controller 23 determines that the negative acknowledgment has not been received (No in Sb5), the controller 23 determines whether a predetermined timeout period has elapsed after the transmission of the data in step Sb2 (Sb7). In a case that the controller 23 determines that the timeout time has elapsed (Yes in Sb7), the controller 23 determines that the base station apparatus 10 has failed to receive the data transmitted in step Sb2 (Sb6). Furthermore, in a case that the controller 23 determines that the timeout period has not elapsed in step Sb7 (No in Sb7), the controller 23 returns to the determination in step Sb3.

Note that in FIG. 4 and FIG. 5, the controller 23 determines that the reception by the base station apparatus 10 has been successful in a case that the data (DI Data) matching the transmitted data (UL Data) is received.

The controller 23 is required to determine whether the base station apparatus 10 has successfully received the signal transmitted from the transmitter 24 to the other terminal apparatus 20 by using the signal from the base station apparatus 10 to the other terminal apparatus 20 received by the receiver 22, and is not limited to the configuration described above. For example, the signal used for the determination may be a control signal (DL Grant) instead of a signal of the transmitted data. In such a case, the control signal may include information for indicating correspondence with the transmitted data (UL Data).

The information for indicating the correspondence with the transmitted data (UL Data) may be, for example, information for indicating a radio resource used for transmitting the data to the base station apparatus 10, or may be information for indicating a control signal (UL Grant) for notifying the radio resource used for transmitting the data to the base station apparatus 10. The information for indicating the radio resource is, for example, an index with the smallest value among the indexes of the resource blocks constituting the radio resource. The information for indicating the control signal (UL Grant) may be identification information included in the control signal (UL Grant), for example, or may be the index with the smallest value among the indexes of the radio resource (control channel element) to which the control signal is mapped.

In FIG. 4, the base station apparatus 10 does not transmit an acknowledgment (ACK) even in a case that the data (UL Data) in the sequence Sa3 has been received successfully. Alternatively, the ACK may be transmitted.

The terminal apparatus 20b does not transmit an acknowledgment (ACK) even in a case that the data (DL Data) in the sequence Sa5 has been received successfully. Alternatively, the ACK may be transmitted.

The group ID used for the control signal for the terminal apparatus 20a and the group ID used for the control signal for the terminal apparatuses 20b may be different from each other. The controllers 23 of the terminal apparatuses 20a and 20b may determine whether the control signal is a control signal for the terminal apparatuses 20a and 20b, depending on the group ID assigned to the control signal.

As described above, in the present embodiment, the controller 23 of the terminal apparatus 20 determines whether the base station apparatus 10 has successfully received the signal transmitted from the transmitter 24 to the other terminal apparatus 20 by using the signal from the base station apparatus 10 to the other terminal apparatus 20 received by the receiver 22. Thus, after receiving a signal transmitted from the transmitter 24 of the terminal apparatus 20 to the other terminal apparatus 20, the base station apparatus 10 can transmit the signal to the other terminal apparatuses 20 before the transmission timing of the acknowledgment. Thus, the delay time until the signal from the terminal apparatus 20 reaches the other terminal apparatus 20 can be shortened.

### Modification of First Embodiment

Hereinafter, a modification of the first embodiment of the present invention will be described in detail with reference to the drawings. In the first embodiment, the terminal apparatus 20 determines whether the base station apparatus 10 has successfully received the signal transmitted from the transmitter 24 to the other terminal apparatus 20 by using the signal from the base station apparatus 10 to the other terminal apparatus 20 received. In the modification of the first embodiment, the terminal apparatus 20 determines whether the base station apparatus 10 has successfully received the signal transmitted from the transmitter 24 to the other terminal apparatus 20 by using the signal from the base station apparatus 10 to the terminal apparatus 20 received.

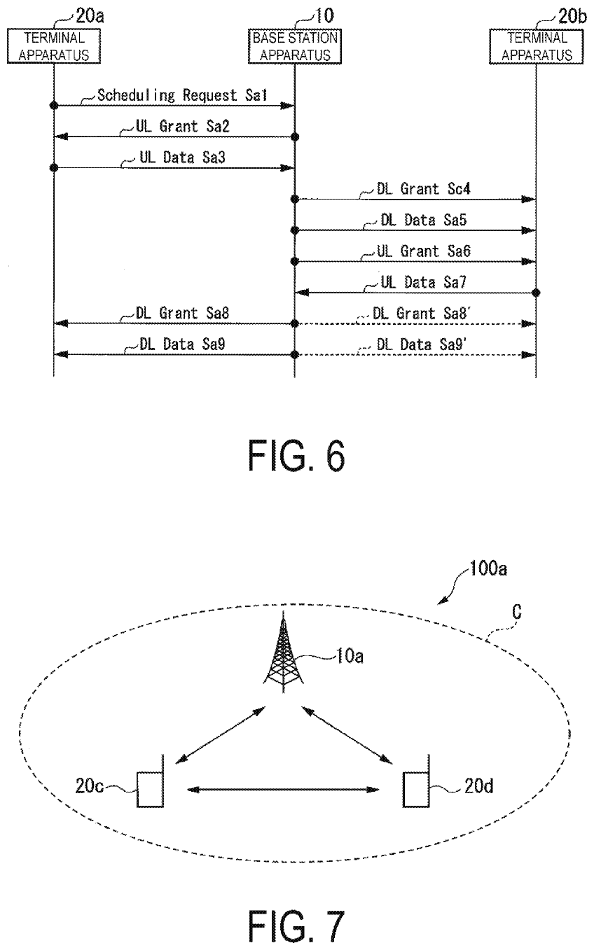

FIG. 6 is a sequence diagram illustrating an example of operations in the radio communication system 100 according to the modification. In FIG. 6, sequences corresponding to the sequences in FIG. 4 are denoted with the same reference signs, and detailed descriptions thereof will be omitted. The sequences illustrated in FIG. 6 differ from the sequences illustrated in FIG. 4 in that it has no sequences Sa4, Sa4′, and Sa5′ and in that it includes a sequence Sc4, instead of the sequence Sa4.

In the sequence Sc4 similar to the sequence Sa4, the controller 13 of the base station apparatus 10 determines a radio resource to be used for transmitting, to the terminal apparatus 20b, the data received in the sequence Sa3, and causes the transmitter 14 to transmit a control signal (DL Grant) indicating the radio resource. The controller 13 assigns an ID (e.g., C-RNTI) of the terminal apparatus 20b to the control signal in a case of transmitting the control signal, and transmits the control signal by using the control channel in the physical layer. Thus, unlike in FIG. 4, the control signal is received only by the terminal apparatus 20b.

Then, in a case that the receiver 22 receives the data (DL Data) transmitted in the sequence Sa9, the controller 23 of the terminal apparatus 20a determines that the data transmitted in the sequence Sa3 has been successfully received by the base station apparatus 10. On the other hand, as in the first embodiment, in a case that the receiver 22 receives the data (DL Data) transmitted in the sequence Sa9′, the controller 23 of the terminal apparatus 20b determines that the data transmitted in the sequence Sa1 has been successfully received by the base station apparatus 10.

As described above, in the present embodiment, the controller 23 of the terminal apparatus 20 determines whether the base station apparatus 10 has successfully received the signal transmitted from the transmitter 24 to the other terminal apparatus 20 by using the signal, received by the receiver 22, that is addressed from the base station apparatus 10 to the terminal apparatus 20. Thus, after receiving a signal transmitted from the transmitter 24 of the terminal apparatus 20 to the other terminal apparatus 20, the base station apparatus 10 can transmit the signal to the other terminal apparatuses 20 before the transmission timing of the acknowledgment. Thus, the delay time until the signal from the terminal apparatus 20 reaches the other terminal apparatus 20 can be shortened.

### Second Embodiment

Hereinafter, a second embodiment of the present invention will be described in detail with reference to the drawings. FIG. 7 is a diagram illustrating a configuration of a radio communication system 100a according to the present embodiment. The radio communication system 100a has almost the same configuration as the radio communication system 100, but is different in that a base station apparatus 10a is included instead of the base station apparatus 10, and terminal apparatuses 20c and 20d are included instead of the terminal apparatuses 20a and 20b. The terminal apparatuses 20c and 20d differ from the terminal apparatuses 20a and 20b in that the terminal apparatuses can communicate directly by direct communication (Sidelink). The base station apparatus 10a differs from the base station apparatus 10 in that it has a function of controlling the direct communication between the terminal apparatuses 20c and 20d.

Note that the base station apparatus 10a has a configuration almost the same as that of the base station apparatus 10 illustrated in FIG. 2, and thus detailed descriptions thereof will be omitted. The terminal apparatuses 20c and 20d have configurations almost the same as that of the terminal apparatus 20 illustrated in FIG. 3, and thus detailed descriptions thereof will be omitted. The terminal apparatuses 20c and 20d directly communicate with each other, and thus the receivers 22 of the terminal apparatuses 20c and 20d each also receive a signal from the other terminal apparatus by using the transmit and receive antenna 21. Similarly, the transmitters 23 of the terminal apparatuses 20c and 20d each use the transmit and receive antenna 21 to transmit a signal to the other terminal apparatus.

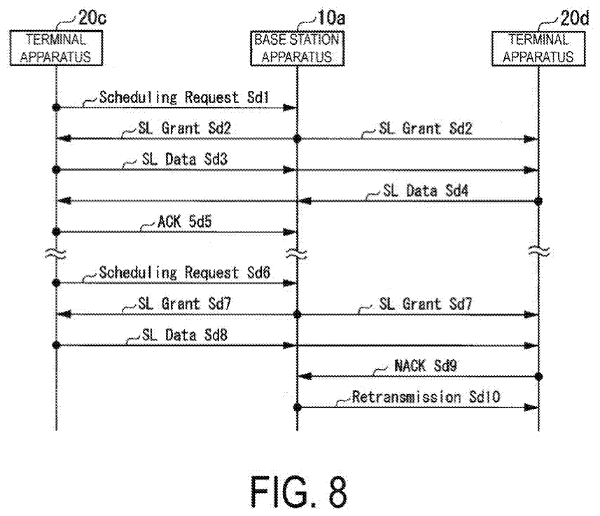

FIG. 8 is a sequence diagram illustrating operations in the radio communication system 100a according to the present embodiment. First of all, the controller 23 of the terminal apparatus 20c causes the transmitter 24 to transmit a scheduling request for performing direct communication with the terminal apparatus 20d. In a case that the receiver 12 receives the scheduling request transmitted in the sequence Sd1, the controller 13 of the base station apparatus 10a determines a radio resource to be used for the direct communication between the terminal apparatuses 20c and 20d, and causes the transmitter 14 to transmit a control signal (SL Grant) indicating the radio resource (Sd2). As in the case of the control signal (DL Grant) in the sequence Sa4 in FIG. 4, an ID of a group including the terminal apparatus 20c and the terminal apparatus 20d is assigned to this control signal, and the resultant signal is transmitted by using a control channel in the physical layer. The ID of the group may be SL-RNTI that is shared by the terminal apparatus 20c and the terminal apparatus 20d.

In a case that the receiver 22 receives the control signal (SL Grant) transmitted in the sequence Sd2, the controller 23 of the terminal apparatus 20c generates, as sidelink data, data directed to the terminal apparatus 20d including a control command and the like, and causes the transmitter 24 to transmit the data to the terminal apparatus 20d using the radio resource indicated by the control signal received (Sd3). In the base station apparatus 10a, the receiver 12 receives this data (SL Data), and the controller 13 stores this data (SL Data) as retransmit data to be described later.

On the other hand, in response to reception of the control signal (SL Grant), transmitted in the sequence Sd2, by the receiver 22, the controller 23 of the terminal apparatus 20d causes the receiver 22 to receive the sidelink data allocated to the radio resource indicated by the control signal, that is, the data transmitted in the sequence Sd3 (SL Data). In a case that the receiver 22 receives the data transmitted in the sequence Sd3 (SL Data), the controller 23 of the terminal apparatus 20d controls the terminal apparatus 20d in accordance with a control command or the like included in the data. The controller 23 of the terminal apparatus 20d generates data, such as a result of the control based on the control command, that is addressed to the terminal apparatus 20c (SL Data), as the sidelink data.

The controller 23 causes the transmitter 24 to transmit the data (SL Data) to the terminal apparatus 20c by using the radio resource indicated by the control signal received in the sequence Sd2. In the base station apparatus 10a, the receiver 12 receives this data (SL Data), and the controller 13 stores this data (SL Data) as retransmit data to be described later. In a case that the receiver 22 receives the data (SL Data) transmitted in the sequence Sd4, the controller 23 of the terminal apparatus 20c causes the transmitter 24 to transmit an acknowledgment (ACK) to the base station apparatus 10a (Sd5). In the base station apparatus 10a, in a case that the receiver 12 receives the acknowledgment, the controller 13 determines that the data transmitted in the sequences Sd3 and Sd4 has been successfully received by the terminal apparatuses 20d and 20c, respectively. Note that in a case that the data transmitted in the sequence Sd4 is received, the controller 13 may determine that the data transmitted in the sequence Sd3 has been successfully received by the terminal apparatus 20d.

Furthermore, as in the case of the sequences Sd1 to Sd3, in a case that the sequences Sd6 to Sd8 are performed and that the receiver 22 of the terminal apparatus 20d receives the data (SL Data) transmitted in the sequence Sd8, it is assumed that abnormality has been detected. In this case, the controller 23 of the terminal apparatus 20d causes the transmitter 24 to transmit a negative acknowledgment (NACK) to the base station apparatus 10a (Sd9). In a case that the receiver 12 receives the negative acknowledgment, the controller 13 of the base station apparatus 10a causes the transmitter 14 to transmit, that is, retransmit the data stored as the retransmission data (Sd10). The data stored by the controller 13 as the retransmission data is the data (SL Data) transmitted in the sequence Sd8 and received by the receiver 12.

Note that in FIG. 8, the sequence is illustrated in which the terminal apparatus 20d transmits a negative acknowledgment. Alternatively, instead of an operation in the sequence Sd5, the terminal apparatus 20c may transmit a negative acknowledgment. In such a case, the base station apparatus 10a receives the data transmitted in the sequence Sd4 (SL Data), and transmits the data that has been stored as retransmission data to the terminal apparatus 20c.

In a physical layer channel in a known sidelink, the sidelink data is repeatedly transmitted multiple times without retransmission, and thus the repeated transmission causes a delay time. In particular, a response to the data transmitted from one terminal apparatus to the other terminal apparatus is transmitted after the repeated transmission, thus causing a transmission timing for the response to have a time delay corresponding to the repeated transmission.

In the present embodiment, the sidelink data is not repeatedly transmitted multiple times as described above, and the base station apparatus 10a also receives the data of the sidelink transmitted by the terminal apparatuses 20c and 20d, and store the data as the retransmission data. Then, in a case that the terminal apparatus 20d or 20c on the receiving side transmits the negative acknowledgment, retransmission is performed by using the retransmission data that has been stored. Therefore, a delay time in direct communication between the terminal apparatus 20c and the terminal apparatus 20 can be suppressed.

### Third Embodiment

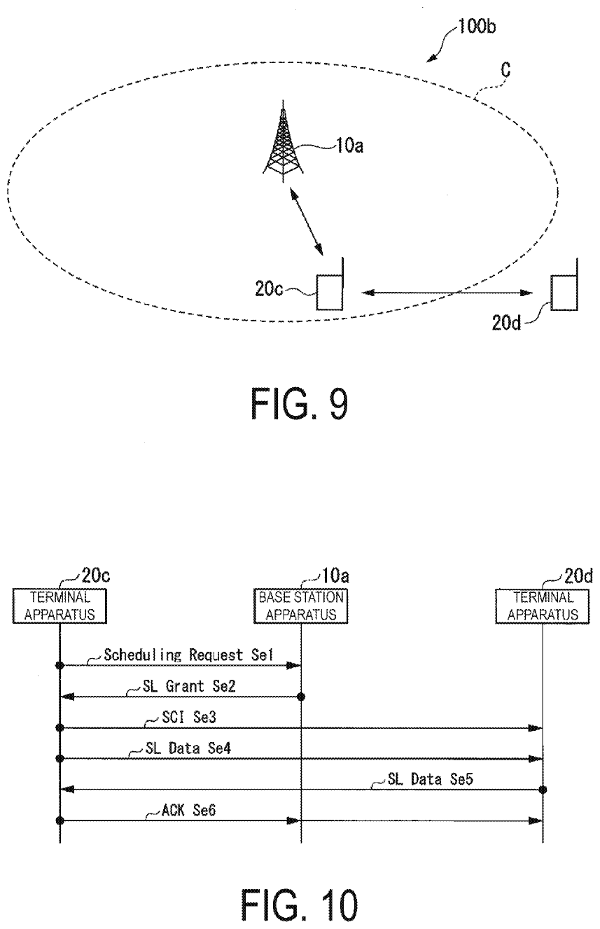

Hereinafter, a third embodiment of the present invention will be described in detail with reference to the drawings. FIG. 9 is a diagram illustrating a configuration of a radio communication system 100b according to the present embodiment. The radio communication system 100b has almost the same configuration as the radio communication system 100a, but differs therefrom in that the terminal apparatus 20d is located outside the cell C.

FIG. 10 is a sequence diagram illustrating operations in the radio communication system 100b according to the present embodiment. First of all, the controller 23 of the terminal apparatus 20c causes the transmitter 24 to transmit a scheduling request for performing direct communication with the terminal apparatus 20d (Se1). In a case that the receiver 12 receives the scheduling request transmitted in the sequence Se1, the controller 13 of the base station apparatus 10b determines a radio resource to be used for the direct communication between the terminal apparatuses 20c and 20d, and causes the transmitter 14 to transmit a control signal indicating the radio resource (SL Grant) (Se2). In a case that the receiver 22 receives the control signal transmitted in the sequence Se2 (SL Grant), the controller 23 of the terminal apparatus 20c causes the transmitter 24 to transmit a control signal (Sidelink control information (SCI)) for indicating a radio resource indicated by the control signal (SL Grant), to the terminal apparatus 20d (Se3).

The controller 23 of the terminal apparatus 20c generates data, addressed to the terminal apparatus 20d, that includes a control command and the like, as sidelink data, and causes the transmitter 24 to transmit the data to the terminal apparatus 20d by using the radio resource indicated by the control signal (SCI) (Se4). On the other hand, in a case that the receiver 22 receives the control signal transmitted in the sequence Se3 (SCI), the controller 23 of the terminal apparatus 20d causes the receiver 22 to receive the sidelink data allocated to the radio resource indicated by the control signal, that is, the data transmitted in the sequence Se4 (SL Data).

In a case that the receiver 22 receives the data transmitted in the sequence Se4 (SL Data), the controller 23 of the terminal apparatus 20d controls the terminal apparatus 20d in accordance with a control command or the like included in the data. The controller 23 of the terminal apparatus 20d generates data, such as a result of the control based on the control command, that is addressed to the terminal apparatus 20c (SL Data), as the sidelink data. The controller 23 causes the transmitter 24 to transmit the data (SL Data) to the terminal apparatus 20c by using the radio resource indicated by the control signal (SCI) received in the sequence Se3 (Se5). In a case that the receiver receives the data transmitted in the sequence Sd4 (SL Data), the controller 23 of the terminal apparatus 20c causes the transmitter 24 to transmit an acknowledgment (ACK) (Se6).

The acknowledgment is received by the base station apparatus 10a and the terminal apparatus 20d.

Therefore, also in the present embodiment, a delay time in direct communication between the terminal apparatus 20c and the terminal apparatus 20 can be suppressed.

The base station apparatus 10 or 10a as well as the terminal apparatuses 20a and 20b or 20c and 20d may be realized by recording a program for realizing the functions of the base station apparatus 10 and the terminal apparatuses 20a and 20b in FIG. 1, or the base station apparatus 10a and the terminal apparatuses 20c and 20d in FIG. 7 and FIG. 9 on a computer-readable recording medium, and causing a computer system to read the program recorded on the recording medium for execution. The “computer system” here includes an OS and hardware components such as a peripheral device.

Furthermore, the “computer-readable recording medium” refers to a portable medium such as a flexible disk, a magneto-optical disk, a ROM, a CD-ROM, and the like, and a storage apparatus such as a hard disk built into the computer system. Moreover, the “computer-readable recording medium” may include a medium, such as a communication line that is used to transmit the program via a network such as the Internet or via a communication line such as a telephone line, that dynamically retains the program for a short period of time, and a medium, such as a volatile memory within the computer system which functions as a server or a client in that case, that retains the program for a fixed period of time. Furthermore, the program may be configured to realize some of the functions described above, and also may be configured to be capable of realizing the functions described above in combination with a program already recorded in the computer system.

The functional blocks of the base station apparatus 10 and the terminal apparatuses 20a and 20b in FIG. 1, and the base station apparatus 10a and the terminal apparatuses 20c and 20d in FIG. 7 and FIG. 9 described above may be individually enabled as a chip, or some or all of the functional blocks may be integrated into a chip. The circuit integration technique is not limited to LSI, and the integrated circuits for the functional blocks may be realized as dedicated circuits or a multi-purpose processor. Any of hybrid and monolithic may be used. Some functions may be implemented by hardware and some functions may be implemented by software.

Furthermore, in a case where with advances in semiconductor technology, a circuit integration technology and the like with which an LSI is replaced appears, it is also possible to use an integrated circuit based on the technology.

The embodiments of the present invention have been described in detail above referring to the drawings, but the specific configuration is not limited to the embodiments and includes, for example, an amendment to a design that falls within the scope that does not depart from the gist of the present invention.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

10, 10a Base station apparatus
11 Receive antenna
12 Receiver
13 Controller
14 Transmitter
15 Transmit antenna
20, 20a, 20b, 20c, 20d terminal apparatus
21 Transmit and receive antenna
22 Receiver
23 Controller
24 Transmitter

1. A terminal apparatus for performing radio communication with another terminal apparatus via a base station apparatus, the terminal apparatus comprising:
a transmitter configured to transmit, to the base station apparatus, a signal of data addressed to the other terminal apparatus;
a receiver configured to receive a signal from the base station apparatus to the often terminal apparatus; and
a controller configured to determine whether the base station apparatus has successfully received the signal of the data transmitted from the transmitter to the other terminal apparatus, by using the signal from the base station apparatus to the other terminal apparatus received by the receiver.

2. The terminal apparatus according to claim 1, wherein
in a case that the receiver receives the signal from the base station apparatus to the other terminal apparatus, the controller compares data obtained by decoding the signal to the other terminal apparatus received and data transmitted from the transmitter to the other terminal apparatus, and determines whether reception by the base station apparatus has been successful.

3. The terminal apparatus according to claim 1, wherein
in a case that the receiver receives a negative acknowledgment to the signal transmitted from the transmitter to the other terminal apparatus, the controller determines that the signal transmitted from the transmitter to the other terminal apparatus has not been successfully received by the base station apparatus.

4. A base station apparatus comprising:
a receiver configured to receive, from a first terminal apparatus, a signal addressed to a second terminal apparatus; and
a transmitter configured to
transmit no acknowledgment to the first terminal apparatus and transmit a signal addressed to the second terminal apparatus, based on the signal addressed to the second terminal apparatus that has been successfully received, in a case that the signal addressed to the second terminal apparatus has been successfully received by the receiver, and
transmit a negative acknowledgment to the first terminal apparatus in a case that the signal addressed to the second terminal apparatus has not been successfully received by the receiver.

5. A communication method for a terminal apparatus for performing radio communication with another terminal apparatus via a base station apparatus, the communication method comprising:
a first step of transmitting, to the base station apparatus, a signal of data addressed to the other terminal apparatus;
a second step of receiving a signal from the base station apparatus to the other terminal apparatus; and
a third step of determining whether the base station apparatus has successfully received the signal of the data, addressed to the other terminal apparatus, that is transmitted in the first step, by using the signal from the base station apparatus to the other terminal apparatus received in the second step.

6. (canceled)

7. (canceled)

8. (canceled)
